(19) United States
(12) Patent Application Publication
(10) Pub. No.: US 2016/0212391 A1
(43) Pub. Date: Jul. 21, 2016

(54) METHOD AND DEVICE FOR PROJECTING CONTENT

(71) Applicants: SONY CORPORATION, TOKYO (JP); SONY NETWORK ENTERTAINMENT INTERNATIONAL LLC, LOS ANGELES, CA (US)

(72) Inventors: TRUE XIONG, SAN DIEGO, CA (US); CHARLES McCOY, CORONADO, CA (US); THOMAS CALABRESE, SAN MARCOS, CA (US)

(21) Appl. No.: 14/600,307

(22) Filed: Jan. 20, 2015

(51) Int. Cl. H04N 9/31

(52) U.S. Cl. CPC H04N 9/31

(57) ABSTRACT

Various aspects of a method and device for projecting content are disclosed herein. The method for projecting content is executed within a content projection device. One or more uneven portions are detected on a surface onto which the content is to be projected. Based on the detected one or more uneven portions on the surface, the projection of the content is adjusted.

### FIELD

Various embodiments of the disclosure relate to projection of content. More specifically, various embodiments of the disclosure relate to adjusting a projection of content for uneven surfaces.

### BACKGROUND

Recent advancements in the field of optical technology have revolutionized the design and functionality of content-projection devices. Such advancements have also led to various types of portable content projection devices. Portable content projection devices are specifically designed for mobile users to project content, such as a video, onto presentation surfaces in various types of environments.

In certain scenarios, a flat presentation surface may not be available for projection of the content. When the presentation surface is uneven, the incident light that corresponds to the content to be projected may be refracted at different angles. Such refraction of the incident light may render a non-uniform/distorted content on the uneven presentation surface. Further, the size of the presentation surface may not be known to the user in advance. Thus, the projected content may appear larger or smaller to the user with respect to the size of the presentation surface. In other scenarios, the projected content may be rendered toward the left, right, top, or bottom side of the presentation surface, due to inappropriate physical orientation of the content projection device. Thus, the existing techniques for content projection may not always provide a desired viewing experience to the user.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a device for projection of content are provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment, in accordance with an embodiment of the disclosure.

FIG. 2 is a block diagram illustrating various components of a content projection device, in accordance with an embodiment of the disclosure.

FIG. 3 illustrates a first exemplary scenario for implementing the disclosed device and method for projecting content, in accordance with an embodiment of the disclosure.

FIG. 4A and FIG. 4B illustrate a second exemplary scenario to implement the disclosed device and method for projecting content, in accordance with an embodiment of the disclosure.

FIG. 5 is a flow chart that illustrates a method to project content, in accordance with an embodiment of the disclosure.

### DETAILED DESCRIPTION

Various implementations may be found in a method and/or a device to project content. The method may be executed within a content projection device. The method may detect one or more uneven portions on a surface on which the content may be projected. Based on the detected one or more uneven portions on the surface, the projection of the content may be adjusted.

In an embodiment, one or more operations may be performed for the adjustment of the projection of the content. The one or more operations may comprise auto key-stoning, panning and/or zooming. In an embodiment, one or more components of the content projection device may be controlled for the adjustment of the projection of the content. The one or more components may comprise a mirror, a lens, and/or a prism.

In an embodiment, the content projection device may determine the depth information of the detected one or more uneven portions. In an embodiment, the depth information may be determined based on a three-dimensional (3D) scan of the surface. In an embodiment, in order to adjust the projection of the content, one or more pixels within the content may be modified based on the determined depth information. In an embodiment, the modification of the one or more pixels may be based on one or more characteristics of the surface. In an embodiment, the one or more characteristics may comprise color, size, orientation, and flatness of the surface.

In an embodiment, one or more pixels of the modified projection may be projected onto the surface at a resolution different from the resolution(s) of remaining pixels of the modified projection. In an embodiment, one or more sets of pixels of the adjusted projection of the content may be projected onto the surface in one or more resolutions. In an embodiment, a first set of pixels may be projected with a first resolution onto the surface. In an embodiment, a second set of pixels may be projected at a second resolution onto the surface.

In an embodiment, a panning operation may be performed for the projection adjustment for a flat surface that is not perpendicular to a direction of projection of the content projection device. In an embodiment, a first region may be detected on the surface for projection of the content. One or more pixels of the projection may be modified based on the detected first region. In an embodiment, the first region may represent one or more blank spaces on the surface. In an embodiment, the detected one or more blank spaces may be eliminated based on a simultaneous zooming operation within a second region and a third region based on the detected first region.

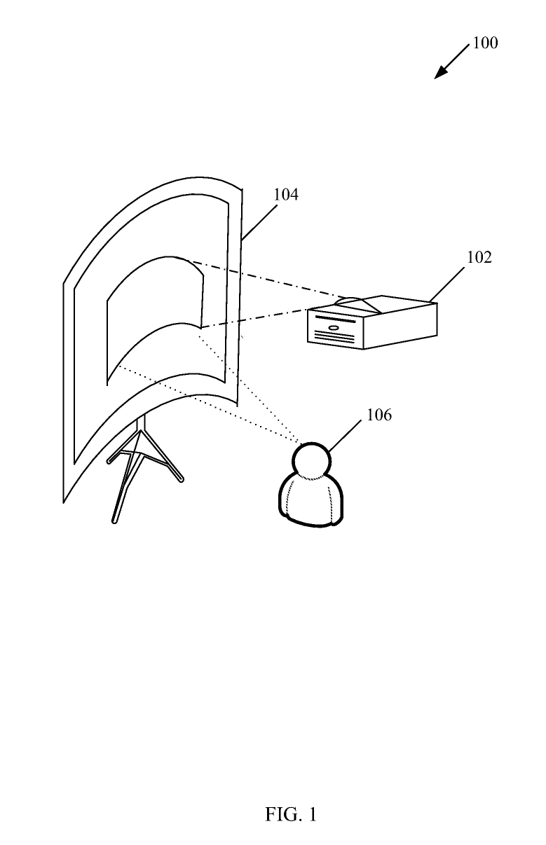

FIG. 1 is a block diagram illustrating a network environment 100, in accordance with an embodiment of the disclosure. With reference to FIG. 1, the network environment 100 may comprise a content projection device 102, a surface 104, and a user 106. The content projection device 102 may be communicatively coupled to one or more electronic devices (not shown), via a wired or a wireless medium. The content projection device 102 may project the projection of the content onto the surface 104. The content projected onto the surface 104 may be viewed by the user 106.

The content projection device 102 may comprise suitable logic, circuitry, interfaces, and/or code that may be operable to project content onto the surface 104. The content projection device 102 may be further operable to adjust or modify the projection of the content. In an embodiment, the content projection device 102 may be embedded within another electronic device, such as a smartphone, a laptop, a tablet, and/or the like. In an embodiment, the content projection device 102 may be a stand-alone device. Examples of the content projection device 102 may include a light-emitting diode (LED) projector, liquid-crystal display (LCD) projector, a laser projector, a retinal projector, and/or the like.

The surface 104 may correspond to a presentation area where the projection of the content may be projected. The surface 104 may be a flat surface, a non-flat surface, and/or an edge. The surface 104 may be a non-uniform combination of 2 or more surfaces aligned to each other. The surface 104 may be associated with one or more characteristics. The one or more characteristics of the surface 104 may comprise, but are not limited to, color, size, orientation, and flatness. Examples of the surface 104 may include a wall, a whiteboard, a projection screen, a solid object and/or the like.

In operation, the content projection device 102 may receive content, which may be projected onto the surface 104, from other electronic devices (not shown). Examples of the content may include, but are not limited to, animated images, still images, video clips, graphics, tables, charts, presentations, illustrations, and/or the like. Examples of the other electronic devices may include, but are not limited to, a laptop, a network video box, a cable television box, a satellite receiver, an Audio-Video (AV) receiver, a camera and/or a disc player (such as a digital versatile disc (DVD) player or a Blu-ray disc player). The content projection device 102 may receive the content from the other electronic devices, via a wired medium, such as a video cable, a Video Graphics Adaptor (VGA) cable, a display port cable, a Digital Visual Interface (DVI) cable and/or a High-Definition Multimedia Interface (HDMI) cable. In an embodiment, the content projection device 102 may receive the content from the other electronic devices, via a wireless medium, such as a wireless HD video transmission medium. In an embodiment, the content projection device 102 may receive the content, such as an over the air television broadcast, via a TV tuner.

In an embodiment, the content projection device 102 may receive content, which may be projected onto surface 104, from a server (not shown), via a communication network (not shown). The server may comprise suitable logic, circuitry, interfaces, and/or code that may be operable to host and/or stream the content to the content projection device 102. The server may be associated with one or more other servers, such as social networking servers, live streaming servers, and/or application servers, to retrieve the content. The server may be implemented as a single server or as a cluster of servers. The server may be implemented as a cloud server which may be configured dynamically during operation of the content projection device 102. The server may be implemented using several technologies that are well known to those skilled in the art. Examples of the server 104 may include Apache™ HTTP Server, Microsoft® Internet Information Services (IIS), IBM® Application Server, and/or Sun Java™ System Web Server. The user 106 may be a human subject that may view the adjusted projection projected by the content projection device 102 onto the surface 104.

The communication network may include a medium through which the content projection device 102, the server, and the one or more other servers may communicate with each other. Such a communication may be performed, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols. The communication network may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN). For the purpose of implementation of the disclosure, the source of the content and the manner in which the content is received by the content projection device 102 should not be construed to limit or restrict the scope of the disclosure.

The content projection device 102 may automatically detect the surface 104 onto which the projection of the content may be projected. In an embodiment, the content projection device 102 may detect the surface 104 from a plurality of available surfaces, based on a manual activation provided by the user 106. In an embodiment, the manual activation may be provided by the user 106, based on an activation of a hardware button (not shown) at the content projection device 102. In an embodiment, the manual activation may be provided by the user 106, via a graphical user interface (GUI) provided on a display screen (not shown) of the content projection device 102.

Based on the detection of the surface 104, the content projection device 102 may further detect one or more uneven portions of the surface 104. In an embodiment, the content projection device 102 may be operable to determine depth information of the detected one or more uneven portions. In an embodiment, the depth information may be determined based on a three-dimensional (3D) scan of the surface 104. In an embodiment, the content projection device 102 may be operable to determine the depth information, based on one or more images captured by one or more image-capturing devices (not shown). In such an embodiment, the content projection device 102 may be communicatively coupled with the one or more image-capturing devices. In an embodiment, one or more image-capturing devices may be integrated within the content projection device 102. The content projection device 102 may receive the captured one or more images, via the communication network. In an embodiment, the content projection device 102 may be operable to determine the depth information based on an output generated by one or more laser devices (not shown). In an embodiment, the one or more laser devices may be integrated within the content projection device 102. Notwithstanding, the disclosure may not be so limited, and a suitable depth-estimation algorithm known in the art may be utilized, without limiting the scope of the disclosure.

Based on the determined depth information, the content projection device 102 may be operable to adjust the projection of the content. In an embodiment, the projection may be adjusted based on one or more operations, such as auto key-stoning, panning and/or zooming, performed on the projection. In an embodiment, the one or more operations may be used to control pixel level modifications within the projection of the content. In an embodiment, the content projection device 102 may be operable to adjust the projection of the content based on a transformation operation. The transformation operation may adjust the projection of the content based on shape and/or orientation of the surface 104. The transformation operation may change the geometry of the projection. Such a change in the geometry of the projection may be achieved when the mapping of the one or more pixels of the content with respect to the one or more pixels of the projection is changed. In an embodiment, the transformation operation may cause the light emitted by the content projection device 102 to produce projection that looks less distorted when viewed. In an embodiment, color corrections may also be performed to adjust the content based on the differences in coloration in the surface 104, such as a non-white surface.

In an embodiment, the projection may be adjusted based on movement of one or more components, such as a plurality of mirrors, of the content projection device 102. In an embodiment, one or more properties of the one or more pixels of the projection may be modified based on one or more characteristics of the surface 104. The content projection device 102 may be operable to project the projection of the content onto the surface 104 based on the one or more modifications of the one or more pixels.

In an embodiment, the content projection device 102 may be coupled to an image capturing device (not shown), such as a camera. The image capturing device may be placed near the user 106 in such a manner that the image capturing device may be operable to capture the projection of the content. Based on the captured projection of the content, the content projection device 102 may adjust the projection such that the content appears without distortions when captured by the image capturing device. In an embodiment, the geometry of the surface 104 and/or orientation of the content projection device 102 with respect to the surface 104 may change during the projection of the content. In such an embodiment, the content projection device 102 may detect the change in the orientation and may dynamically adjust the projection of the content based on the detected change in the orientation.

In an exemplary implementation, the content projection device 102 may detect a first region on the surface 104. In an embodiment, the detected first region may be one or more blank spaces on the surface 104. Based on the detected first region, the content projection device 102 may adjust the projection of the content by modification of one or more pixels within the projection. The content projection device 102 may adjust the projection based on a simultaneous zooming operation within a second region and a third region. In an embodiment, the simultaneous zooming operation is performed in order to eliminate the detected first region. In an embodiment, one or more sets of pixels of the adjusted projection of the content may be projected on the surface 104 based on one or more different respective resolutions. For example, a first set of pixels may be projected onto the surface 104 based on a first resolution and a second set of pixels may be projected onto the surface 104 based on a second resolution.

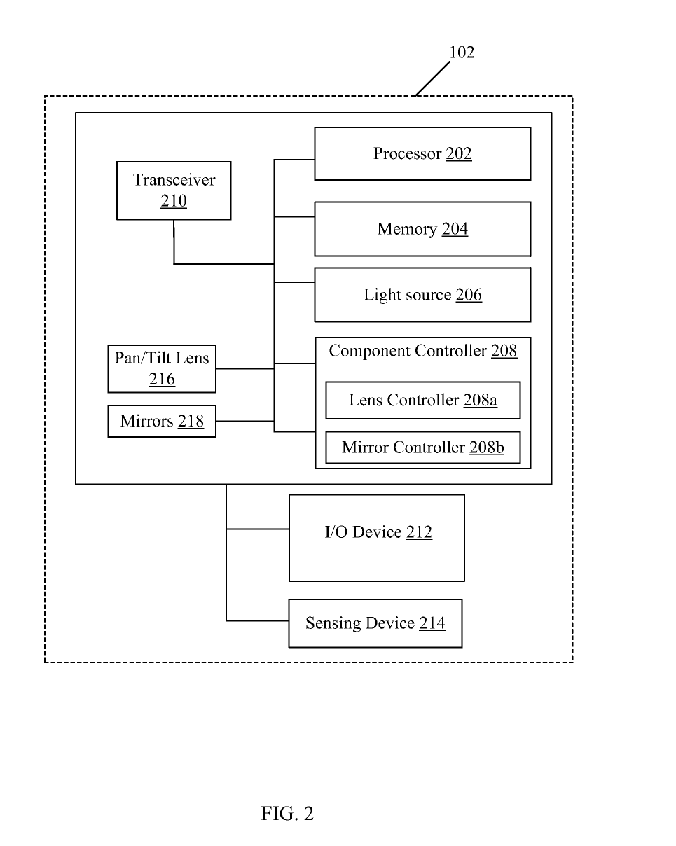

FIG. 2 is a block diagram illustrating various components of the content projection device 102, in accordance with an embodiment of the disclosure. FIG. 2 is explained in conjunction with elements from FIG. 1. With reference to FIG. 2, there is shown the content projection device 102. The content projection device 102 may comprise one or more processors, such as a processor 202, a memory 204, a light source 206, a component controller 208, a transceiver 210, an input/output (I/O) device 212, a sensing device 214, a pan/tilt lens 216, and a plurality of mirrors 218. The component controller 208 may comprise a lens controller 208a, and a mirror controller 208b.

The processor 202 may be communicatively connected to the memory 204, the light source 206, the component controller 208, the transceiver 210, the I/O device 212, the sensing device 214, the pan/tilt lens 216, and the plurality of mirrors 218. The transceiver 210 may be communicatively coupled with the communication network, the processor 202 and the memory 204. The component controller 208 may be operable to simultaneously control back-and-forth movement of the pan/tilt lens 216 and the plurality of mirrors 218, which may be arranged along an optical axis.

The processor 202 may comprise suitable logic, circuitry, interfaces, and/or code that may be operable to execute a set of instructions stored in the memory 204. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processor.

The memory 204 may comprise suitable logic, circuitry, interfaces, and/or code that may be operable to store the set of instructions, which may be executed by the processor 202. The memory 204 may be further operable to store one or more image-processing algorithms. Examples of the one or more image-processing algorithms may include, but are not limited to, a Canny edge detector, error diffusion, histogram equalization, and/or Marr-Hildreth algorithm. The memory 204 may be further operable to store one or more depth processing algorithms, such as the Kirchhoff depth algorithm and/or specular beam imaging. In an embodiment, the memory 204 may be operable to store the content that may be projected onto the surface 104. The memory 204 may be further operable to store one or more software codes related to an auto key-stoning operation. The memory 204 may be implemented based on a Random Access Memory (RAM), a Read-Only Memory (ROM), a Hard Disk Drive (HDD), a storage server, and/or a Secure Digital (SD) card.

The light source 206 may comprise suitable circuitry that may be operable to provide a beam of light that may be decomposed into a plurality of color components, such as a red (R) component, a green (G) component, and a blue (B) component (collectively referred to as the RGB color components). In an embodiment, the light source 206 may include other color components, in addition to the RGB color components, without limiting the scope of the disclosure. In an embodiment, the light source 206 may be an array of light emitting diodes (LEDs). In an embodiment, light source 206 may be an array of lasers. In an embodiment, light source 206 may be a set of laser diodes. Notwithstanding, the disclosure may not be so limited, and another suitable light source may be utilized, without limiting the scope of the disclosure.

The component controller 208 may control one or more components, such as the pan/tilt lens 216 or the plurality of mirrors 218. The controlling of the one or more components may be implemented using conventional implementations known in the art. The one or more components may be controlled so that the one or more pixels of the content may be modified. The component controller 208 may comprise the lens controller 208a and the mirror controller 208b. The lens controller 208a may be operable to control the pan/tilt lens 216. The lens controller 208a may be operable to control the pan/tilt lens 216 to modify the one or more pixels within the projection of the content, based on the depth information. The mirror controller 208b may be operable to control the plurality of mirrors 218 to modify one or more pixels within the projection of the content, based on the depth information. In an embodiment, the mirror controller 208b and the plurality of mirrors 218 may be optional components of the content projection device 102. In an embodiment, the component controller 208 may further comprise a liquid-crystal display (LCD) screen controller (not shown). The LCD screen controller may be used to control one or more LCD screens (not shown) within content projection device 102. In an embodiment, the one or more LCD screens may be implemented as a grid of Light Emitting Diodes (LED).

The transceiver 210 may comprise suitable logic, circuitry, interfaces, and/or code that may be operable to receive content from external resources, such as the server, via the communication network. The transceiver 210 may implement known technologies to support wired or wireless communication with the communication network. The transceiver 210 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 212 may comprise suitable logic, circuitry, interfaces, and/or code that may be operable to receive an input or provide an output to the user 106. The I/O device 212 may comprise various input and output devices that may be operable to communicate with the processor 202. Examples of the input devices may include, but are not limited to, a keyboard, a mouse, a joystick, a touch screen, a microphone, a camera, an infrared (IR) receiver, and/or a docking station. Examples of the output devices may include, but are not limited to, the display screen and/or a speaker.

The sensing device 214 may comprise suitable logic, circuitry, and/or interfaces that may be operable to include one or more sensors configured to detect one or more parameters. The one or more parameters may be associated with one or more environmental conditions and/or projection surfaces. The one or more parameters may comprise a luminance value of the ambient environment that may include the content projection device 102 and the surface 104. The one or more parameters may further comprise depth information of one or more uneven portions of the surface 104. In an implementation, the one or more sensors may detect light emitted by the light source 206. Examples of the one or more sensors may include, but are not limited to, an image sensor, a light sensor, a depth sensor, a laser range finder, and/or sound navigation and ranging (SONAR).

The pan/tilt lens 216 may be operably connected to the processor 202, the memory 204 and the sensing device 214. The pan/tilt lens 216 may be utilized to adjust the projection of the content for projection onto the surface 104. In an embodiment, the pan/tilt lens 216 may be controlled in such a manner that one or more pixels within the projection may be modified to adjust the projection based on the depth information.

The plurality of mirrors 218 may be connected to the processor 202, the memory 204, and the sensing device 214. The plurality of mirrors 218 may be controlled for adjustment of the projection. The plurality of mirrors 218 may be arranged in an alternate position with respect to each other. The plurality of mirrors 218 may be of a predetermined configuration. The plurality of mirrors 218 may be arranged in such a manner that a back and forth movement is possible, based on the one or more parameters detected by the sensing device 214.

In operation, the transceiver 210 may receive the content from other electronic devices, via one of a video cable, a Video Graphics Adaptor (VGA) cable, a display port cable, a Digital Visual Interface (DVI) cable and/or a High-Definition Multimedia Interface (HDMI) cable. In an embodiment, the transceiver 210 may receive the content from the other electronic devices, via a wireless medium, such as wireless HD video transmission. In an embodiment, the transceiver 210 may receive an over the air television broadcast, via a TV tuner. In an embodiment, the transceiver 210 may receive the content from the other electronic devices, via a wired medium, such as a video input connector. Examples of the video input connector may include, but are not limited to, an Enhanced video connector (EVC), an HDMI interface connector, a VGA connector, and/or a DVI connector. In an embodiment, the transceiver 210 may receive content from a server, via the communication network. In an embodiment, the transceiver 210 may retrieve content to be projected from the memory 204 of the content projection device 102. In an embodiment, the transceiver 210 may retrieve content via an external memory source, such as, a USB drive. The transceiver 210 may be operable to communicate the content to the processor 202. In an embodiment, the processor 202 may be operable to retrieve the content stored in the memory 204.

In an embodiment, the sensing device 214 may detect the surface 104 on which the projection of the content may be projected. In an embodiment, the sensing device 214 may also be utilized to determine available area on the surface 104 for projection of the content. In an embodiment, the sensing device 214 may detect the surface 104, based on light flashed by the light source 206. In an embodiment, the surface 104 may be detected based on a manual activation of a hardware and/or software button provided by the user 106. The hardware and/or software button may be disposed on the content projection device 102.

The manual activation may be provided by the user 106, via a touchscreen of the content projection device 102. Based on the user selection, the adjusted projection may be projected onto the surface 104. In accordance with an exemplary scenario, an object may be used as a surface 104 for projection of content. For example, a globe (a projection surface) may be placed between a wall (another projection surface) and the content projection device 102. The user 106 may manually select a hardware or software button, associated with the content projection device 102, to select one or both of the projection surfaces for content projection.

In an embodiment, the sensing device 214 may be operable to detect one or more uneven portions on the surface 104 on which the projection may be projected. Based on the detection of the one or more uneven portions of the surface 104, the sensing device 214 may determine the depth information of the one or more uneven portions. The depth information may be determined by one or more image-capturing devices and/or one or more laser devices, in conjunction with one or more depth-estimation algorithms. The one or more depth-estimation algorithms, such as, but not limited to Kalman-Filter based algorithm, may be retrieved from the memory 204. In an embodiment, the depth information may be determined based on a 3D scan of the surface 104. In an embodiment, the sensing device 214 may detect a shape of the surface 104. In an embodiment, the surface 104 may be symmetrical in shape, such as rectangle or square. In an embodiment, the surface 104 may be asymmetrical in shape, such as trapezoid and the like. In an embodiment, the sensing device 214 may be communicatively coupled with the component controller 208, to control a zoom operation on the projection of the content. In an embodiment, the component controller 208 may control the one or more components that perform a zoom operation. The zoom operation may be performed in such a manner that the projection may be adjusted to fit in a symmetric shape when the surface 104 has an asymmetric surface area.

In an embodiment, based on the depth information of the one or more uneven portions, the processor 202, in conjunction with the component controller 208, may adjust the projection of the content. The component controller 208 may be operable to control one or more components of the content projection device 102 to generate the adjusted projection. In an embodiment, the lens controller 208a may control the movement of the pan/tilt lens 216. In an embodiment, the mirror controller 208b may control the movement of the plurality of mirrors 218. The component controller 208 may modify the one or more pixels within the projection of the content. In an embodiment, the projection may be adjusted by projection of the content onto the plurality of mirrors 218 arranged in an alternate position with respect to each other. The plurality of mirrors 218 may move back-and-forth with respect to a reference position. In an embodiment, the back-and-forth movement of the plurality of mirrors 218 may be based on the detected depth information. In an embodiment, the adjusted projection may comprise off-centered zoomed content.

In an embodiment, the component controller 208 may generate the adjusted projection based on a curvature of the surface 104. In an embodiment, the one or more pixels of the projection may be modified based on one or more of an auto key-stoning operation, a panning operation, and/or a zooming operation, in conjunction with an image-processing algorithm. In an embodiment, the auto key-stoning operation may detect the output shape of the adjusted projection based on the sensing device 214. In an embodiment, the LCD screen controller may control the one or more LCD screens such that each of the color channels (red channel, green channel, blue channel) of the adjusted projection may be combined using a dichroic prism (not shown). In response to the generation of the adjusted projection, the content projection device 102 may project the adjusted projection onto the surface 104.

In an embodiment, the processor 202 may detect a first region on the surface 104. In an embodiment, the detected first region may be one or more blank spaces on the surface 104. Based on the detected first region, the processor 202 may adjust the projection by modification of one or more pixels within the content. The processor 202 may adjust the projection based on a simultaneous zooming operation within a second region and a third region. In an embodiment, the simultaneous zooming operation is performed in order to eliminate the detected first region. In an embodiment, one or more sets of pixels of the adjusted projection may be projected on the surface 104 based on one or more different respective resolutions. For example, a first set of pixels may be projected onto the surface 104 based on a first resolution and a second set of pixels may be projected onto the surface 104 based on a second resolution.

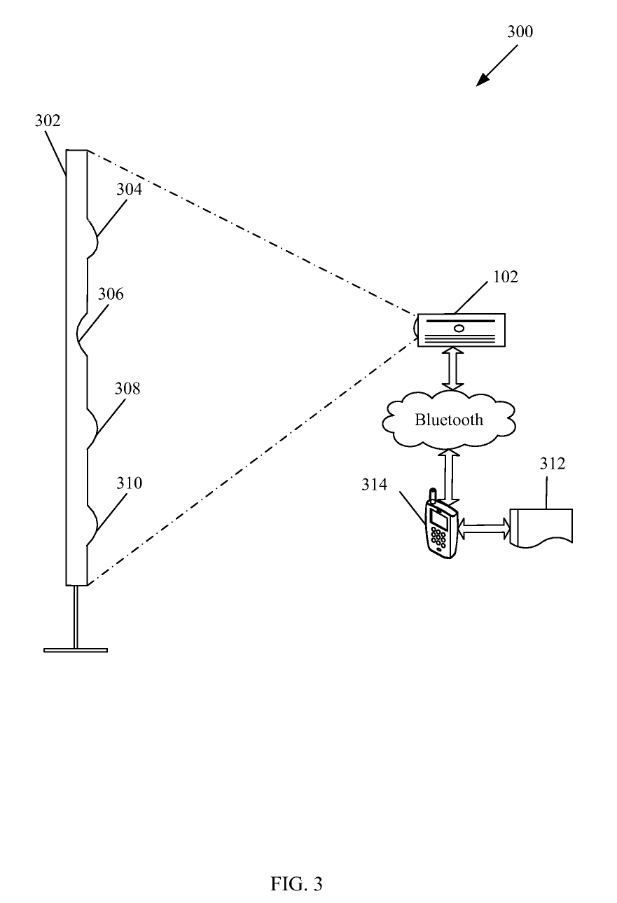

FIG. 3 illustrates a first exemplary scenario 300 to implement the disclosed device and method to project content, in accordance with an embodiment of the disclosure. FIG. 3 is explained in conjunction with elements from FIG. 1 and FIG. 2. With reference to FIG. 3, there is shown a curved presentation surface 302. The curved presentation surface 302 may comprise one or more uneven portions, such as 304, 306, 308, and 310. In an example scenario, the content projection device 102 may be operable to receive an image 312 from a smartphone 314, via Bluetooth®. The content projection device 102 may be operable to detect the one or more uneven portions and project an adjusted projection of the image onto the curved presentation surface 302.

With reference to FIG. 3, the uneven portion 304 may correspond to a first portion of the projection of the image 312. In an embodiment, the first portion of the image 312 may be projected onto the curved presentation surface 302, with a first resolution, such as “R1”. The uneven portion 306 may correspond to a second portion of the projection of the image 312. In an embodiment, the second portion of the image 312 may be projected onto the curved presentation surface 302, with a second resolution, such as “R2”. The uneven portion 308 may correspond to a third portion of projection of the image 312. In an embodiment, the third portion of the image 312 may be projected onto the curved presentation surface 302, with a third resolution, such as “R3”. Similarly, the uneven portion 310 may correspond to a fourth portion of the projection of the image 312. In an embodiment, the fourth portion of the image 312 may be projected onto the curved presentation surface 302, with a fourth resolution, such as “R4”.

In an embodiment, the component controller 208 may be operable to control the one or more components to modify one or more pixels of one or more portions (projections) of the image 312 on the corresponding uneven portions. In accordance with the first exemplary scenario 300, the one or more portions of the image 312 may be a first, second, third, and fourth portions that may correspond to the uneven portions of the curved presentation surface 302, such as 304, 306, 308, and 310, respectively. The original resolutions of the first, second, third, and fourth portions may be “R1”, “R2”, “R3”, and “R4”, respectively. The component controller 208 may control one or more components to modify the one or more pixels to update the original resolutions to modified resolution values, such as, “R5”, “R6”, “R7”, and “R8”, respectively. The content projection device 102 may adjust the projection of image 312, based on such modified resolutions of the one or more portions of the projection of image 312. The adjusted projection of the image 312 may appear as an undistorted image on the curved presentation surface 302.

In an embodiment, the processor 202 may transmit a command to the component controller 208 to control the one or more components. The one or more components may be controlled to modify one or more characteristics of the pixels of the projection of the image 312 that may be projected onto the curved presentation surface 302. The one or more characteristics of the pixels may include color, shading, size, orientation, flatness, and/or the like. In an embodiment, the processor 202 may be operable to control the one or more components to modify one or more portions of the projection of the image 312 on the corresponding uneven portions. In accordance with the first exemplary scenario 300, the one or more portions of the projection of the image 312 may be a first, second, third, and fourth portions that may correspond to the uneven portions of the curved presentation surface 302, such as 304, 306, 308, and 310, respectively. The original colors of the first, second, third, and fourth portions may be “C1”, “C2”, “C3”, and “C4” respectively. The processor 202 may modify the one or more pixels to update the original colors to modified colors such as “C5”, “C6”, “C7”, and “C8”, respectively. In an embodiment, the first portion may be at a curved edge of the curved presentation surface 302 with the original color “C1”. The processor 202 may update the original color “C1” to the modified color “C5” to modify one or more portions of the projection of the image 312. In an embodiment, if the one or more portions of the surface are uneven, then the image may appear distorted. However, the adjusted projection of the image 312 may appear as an undistorted image on the curved presentation surface 302 based on the one or more modifications performed by the processor 202.

In an embodiment, the curved presentation surface 302 may have a specific color, such as red. The image 312 may comprise one or more portions that may be of the same color, such as red. Thus, the one or more red portions may not be visible on the curved presentation surface 302. The content projection device 102 may identify such one or more portions. The content projection device 102 may modify one or more pixels within the identified one or more portions, based on one or more parameters. Examples of the one or more parameters may include, but are not limited to, contrast, hue, and/or saturation. Based on such modification, the visibility of the one or more portions may be enhanced.

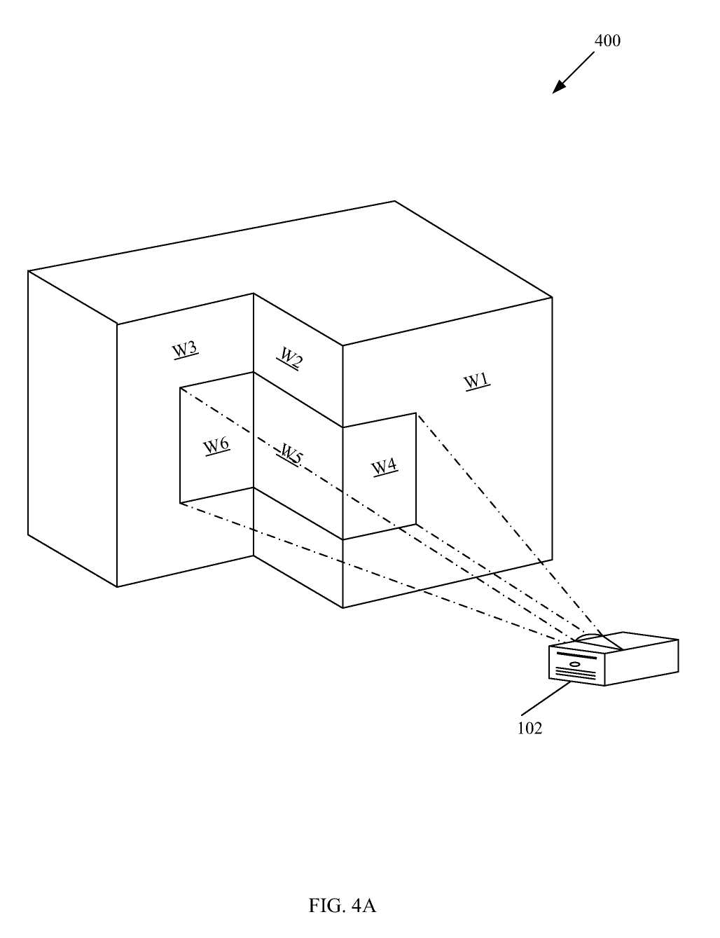

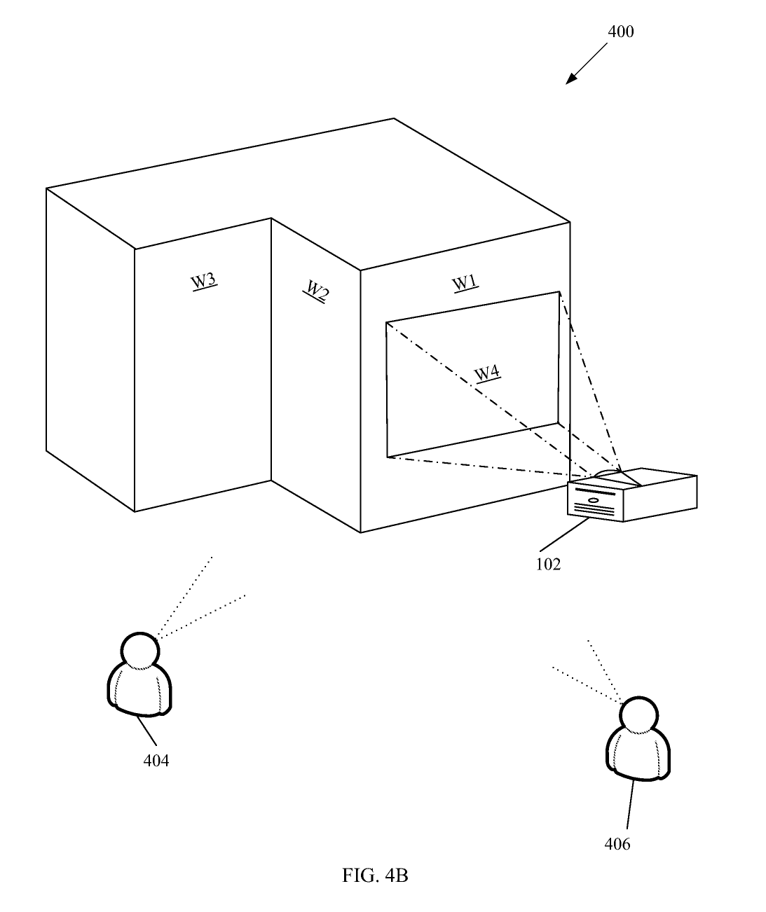

FIG. 4A and FIG. 4B illustrate a second exemplary scenario 400 to implement the disclosed device and method to project content, in accordance with an embodiment of the disclosure. FIG. 4A and FIG. 4B is explained in conjunction with elements from FIG. 1 and FIG. 2. In accordance with the second exemplary scenario 400, an uneven presentation surface, such as a wall with one or more stepped edges, may be available as a presentation surface. The surfaces of the wall may be referred to as, “W1”, “W2”, and “W3”. The wall, “W1”, may comprise a blank space that may be utilized to project the content by the content projection device 102. Such a blank space on the wall, “W1”, may be detected by the sensing device 214 and communicated to the content projection device 102.

With reference to FIG. 4A, an unadjusted retrieved content may be projected as a distorted image on the walls “W1”, “W2”, and “W3”. The projection areas on the walls “W1”, “W2”, and “W3” may be represented as, “W4”, “W5”, and “W6”. Unused area of the walls “W1”, “W2”, and “W3” may be detected by the sensing device 214 as a blank space on each of the walls “W1”, “W2”, and “W3”.

With reference to FIG. 4B, the content projection device 102 may detect the blank space on the wall “W1”. Based on the detection of the blank space on the wall “W1”, the content projection device 102 may control one or more components, such as the pan/tilt lens 216 and/or plurality of mirrors 218 of the content projection device 102. The one or more components of the content projection device 102 may modify one or more pixels within the projection of the content that may be projected on a portion “W4” of the wall “W1”. The component controller 208 may control the plurality of mirrors 218, arranged in an alternate position with respect to each other, to modify one or more pixels of the projection of the content. In an embodiment, the plurality of mirrors 218 may be moved back and forth to modify the projection of the content. In an embodiment, the projection of the content may be modified based on one or more operations of auto key-stoning, panning and/or zooming. The one or more operations may be used to control pixel level modifications within the projection of the content.

In an embodiment, the content projection device 102 may modify one or more pixels within the projection of the content such that the panning angle of the adjusted projection may be optimized for one or more users. A panning operation may adjust the panning angle such that one or more pixels of the projection may be modified. The one or more pixels may be modified such that the modification may adjust the projection of the content for projection on a flat surface that is not perpendicular to a direction of projection of the content projection device 102. Thus, a user 404 and a user 406, with different positions with respect to the wall “W1”, may view the adjusted projection projected at the portion “W4” in an undistorted manner.

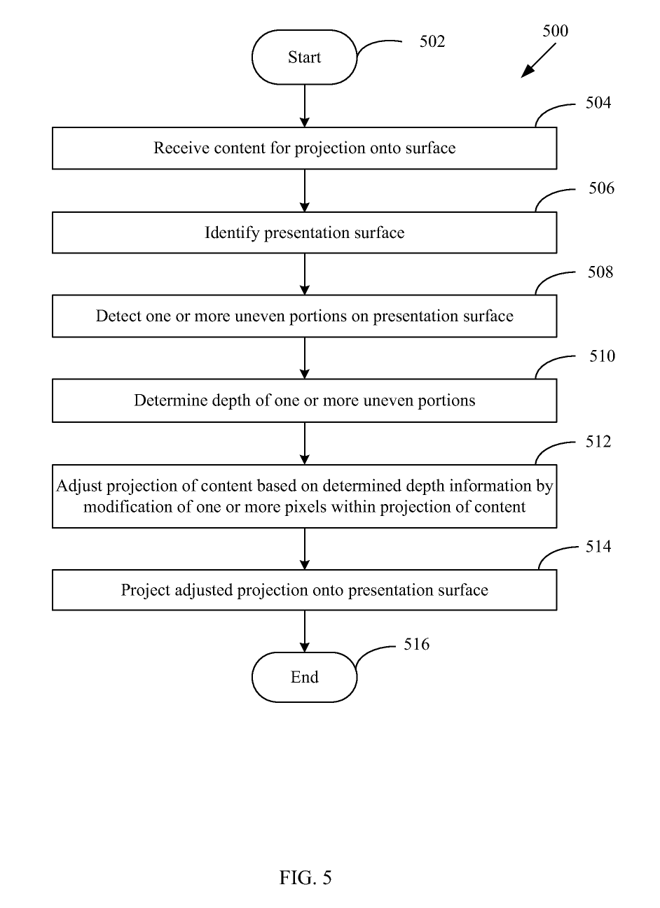

FIG. 5 is a flow chart that illustrates a method 500 to project content, in accordance with an embodiment of the disclosure. FIG. 5 is described in conjunction with elements of FIG. 1, and FIG. 2. With reference to FIG. 5, the method may be implemented in the content projection device 102.

The method 500 begins at step 502 and proceeds to step 504. At step 504, the content may be received for projection onto the surface 104. The content to be projected may be received from another electronic device, such as a laptop, a network video box, a cable television box, a satellite receiver, an AV receiver, a camera and/or a disc player. In an embodiment, the content may be retrieved from a local memory within the content projection device 102. In an embodiment, the content may be retrieved from the server. At step 506, the surface 104 may be identified. In an embodiment, an available area for presentation on the surface 104 may be determined. At step 508, one or more uneven portions on the surface 104 may be detected. At step 510, the depth of the detected one or more uneven portions may be determined. At step 512, the projection of the content may be adjusted, based on the determined depth information, by modification of one or more pixels within the projection of the content. In an embodiment, one or more operations, such as auto key-stoning, panning and/or zooming, may be performed for the modification of the one or more pixels. In an embodiment, the one or more components may be controlled based on the determined depth information for the modification of the one or more pixels. At step 514, the adjusted projection of the content may be projected onto the surface 104. Control passes to end step 516.

In accordance with an embodiment of the disclosure, the content projection device 102 (FIG. 1) may comprise one or more circuits for projecting content. The one or more circuits may be operable to detect one or more uneven portions on a surface 104, on which the content may be projected. Based on the detected one or more uneven portions on the surface 104 (FIG. 1), the processor 202 may be operable to adjust the projection of the content.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer for projecting content. The at least one code section in an electronic device may cause the machine and/or computer to perform the steps, which may comprise detection of one or more uneven portions on a surface onto which the content is to be projected. Based on the detected one or more uneven portions on the surface, the projection of the content may be adjusted.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for projection of content on a surface, said method comprising:
in a content projection device:
detecting one or more uneven portions on said surface; and
adjusting said projection of said content based on said detected one or more uneven portions on said surface.

2. The method of claim 1, further comprising performing one or more operations for said adjustment of said projection of said content, wherein said one or more operations comprise one or more of: auto key-stoning, panning and/or zooming.

3. The method of claim 1, further comprising controlling one or more components of said content projection device for said adjustment of said projection of said content, wherein said one or more components comprise one or more of: a mirror, a lens, and/or a prism.

4. The method of claim 1, further comprising determining depth information of said detected said one or more uneven portions.

5. The method of claim 4, comprising determining said depth information of said one or more uneven portions based on a three-dimensional (3D) scan of said surface.

6. The method of claim 4, further comprising modifying one or more pixels within said projection of said content based on said determined depth information for said adjustment of said projection of said content.

7. The method of claim 1, further comprising modifying one or more pixels based on one or more characteristics of said surface.

8. The method of claim 7, wherein said one or more characteristics comprises color, size, orientation, and flatness of said surface.

9. The method of claim 1, comprising:
projecting a first set of pixels of said adjusted projection of said content on said surface at a first resolution; and
projecting a second set of pixels of said adjusted projection of said content on said surface at a second resolution.

10. The method of claim 1, further comprising performing a panning operation for said adjustment of said projection of said content for a flat surface that is not perpendicular to a direction of projection of said content projection device.

11. The method of claim 1, comprising:
detecting a first region on said surface available for said projection of said content; and
adjusting said projection of said content based on said detected said first region.

12. The method of claim 11, wherein said first region represents one or more blank spaces on said surface.

13. The method of claim 11, wherein said projection of said content is adjusted based on a simultaneous zooming operation within a second region and a third region based on said detected said first region.

14. A content projection device for projection of content on a surface, said content projection device comprising:
one or more circuits operable to:
detect one or more uneven portions on said surface; and
adjust said projection of said content based on said detected one or more uneven portions on said surface.

15. The content projection device of claim 14, wherein said one or more circuits are operable to perform one or more operations and/or control one or more components for said adjustment of said projection of said content.

16. The content projection device of claim 14, wherein said one or more circuits are operable to determine depth information of said detected said one or more uneven portions.

17. The content projection device of claim 16, wherein said one or more circuits are operable to determine said depth information of said one or more uneven portions based on a three-dimensional (3D) scan of said surface.

18. The content projection device of claim 16, wherein said one or more circuits are operable to modify one or more pixels within said projection of said content based on said determined depth information for said adjustment of said projection of said content.

19. The content projection device of claim 14, wherein said one or more circuits are operable to modify one or more pixels based on one or more characteristics of said surface, wherein said one or more characteristics comprises color, size, orientation, and/or flatness of said surface.

20. The content projection device of claim 14, wherein said one or more circuits are operable to:
project a first set of pixels of said adjusted projection of said content on said surface at a first resolution; and
project a second set of pixels of said adjusted projection of said content on said surface at a second resolution.

21. The content projection device of claim 14, wherein said one or more circuits are operable to perform a panning operation for said adjustment of said projection of said content for a flat surface that is not perpendicular to a direction of projection of said content projection device.

22. The content projection device of claim 14, wherein said one or more circuits operable to:
detect a first region on said surface available for said projection of said content, wherein said first region corresponds to one or more blank spaces on said surface; and
adjust said projection of said content by based on said detected said first region.

23. The content projection device of claim 22, wherein said content is adjusted based on a simultaneous zooming operation within a second region and a third region based on said detected said first region.

24. A non-transitory computer readable storage medium having stored thereon, a computer program having at least one code section for projection of content, the at least one code section being executable by a computer for causing the computer to perform steps comprising:
detecting one or more uneven portions on a surface onto which said content is to be projected; and
adjusting said projection of said content based on said detected one or more uneven portions on said surface.
